(19) United States
(12) Patent Application Publication
(10) Pub. No.: US 2018/0139322 A1
(43) Pub. Date: May 17, 2018

(54) MODIFICATION OF MOBILE COMPUTING DEVICE BEHAVIOR

(71) Applicant: SAP SE, Walldorf (DE)

(72) Inventors: Martin Knechtel, Dresden (DE); Axel Schroeder, Dresden (DE)

(21) Appl. No.: 15/349,434

(22) Filed: Nov. 11, 2016

(51) Int. Cl. H04M 1/725; H04W 4/00

(52) U.S. Cl. CPC H04M 1/72569; H04M 1/72577; H04M 1/72572; H04W 4/005

(57) ABSTRACT

A user input to the mobile computing device can be detected wherein the user input changes a setting of the mobile computing device. In response to the detecting of the user input, a context can be obtained. The context can be associated with an environment of the mobile computing device. A rule set can be generated that is based on both the user input and the context. The rule set can include a set of settings for the mobile computing device that dictate a behavior of one or more features of the mobile computing device. The generated rule set can be implemented in response to an indication that the mobile computing device is in an environment associated with the context.

### TECHNICAL FIELD

The subject matter described herein relates to managing devices and in particular managing when devices that provide notifications to users based on sensor output signals.

### BACKGROUND

The proliferation of mobile computing devices having complex sensor equipment means that it is possible to obtain large amounts of data about our day-to-day activities. Mobile computing devices can also provide notifications and can be intrusive in doing so.

### SUMMARY

In one aspect, a method is described for being performed by at least one computer processor forming at least a part of a computing system. The operations of the method can include detecting, at a mobile computing device, a user input to the mobile computing device. The user input can include changing a setting of the mobile computing device. A context can be obtained in response to the detecting of the user input. The context associated with an environment of the mobile computing device. A rule set can be generated based on the user input and the context. The rule set can include a set of settings for the mobile computing device that dictate a behavior of one or more features of the mobile computing device. The rule set can be implemented by the mobile computing device in response to an indication that the mobile computing device has entered an environment associated with the context.

In some variations the method may include one or more of the following features. The obtaining of the context can be based on an output signal generated by a sensor of the mobile computing device. The output signal can includes an indication of an environmental factor of the environment of the mobile computing device. For example, the sensor can be a microphone and the context of the environment can include a noise level of the environment. As another example, the sensor can be a transceiver and the context of the environment can include a plurality of other mobile computing devices within a predefined distance of the mobile computing device detected by the transceiver. As a further example, the sensor can be a light sensor and the context of the environment can be a luminosity level of the environment. The obtaining of the context can be based on a plurality of output signals from a plurality of sensors of the mobile computing device.

The obtaining of the context can be based on personal information associated with a user of the mobile computing device. For example, personal information can include a home address, a work address, event information associated with the user, demographic information, or the like.

In some variations, the set of settings can include a volume of a notification sound of the mobile computing device.

In some variations, the generating of the rule set can includes determining a pattern between a plurality of user inputs to the mobile computing device and a plurality of contexts associated with an environment of the mobile computing device. The rule set can be generated based on the determined pattern. The mobile computing device can be associated with a user belonging to a user group. A user group rule set can be obtained by the mobile computing device. The user group rule set can be associated with the user group. The user group rule set can be implemented by the mobile computing device that is associated with the user belonging to the user group.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. For example, mobile computing devices are described that are configured to include and/or implement one or more of the features described herein. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a smartphone, smartwatch, tablet, or the like, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an illustration of a system having one or more features consistent with the present description;

FIG. 2 is a schematic illustration of a mobile computing device having one or more features consistent with the present description;

FIG. 3 is an illustration of a plurality of mobile computing devices having one or more features consistent with the present description;

FIG. 4 is an illustration of a system architecture having one or more features consistent with the present description; and

FIG. 5 illustrates a method having one or more features consistent with then current subject matter.

### DETAILED DESCRIPTION

Mobile computing devices are becoming ubiquitous. Mobile computing devices can include smartphones, smartwatches, fitness trackers, laptops, tablets, notebooks, or the like. Most mobile computing devices are configured to provide notifications to users of the mobile computing devices. Such notifications can include receipt of a message, receipt of an email, reminder of an event, a change in the weather, alerts associated with occurring events, or the like. Notifications may be visual, audible, and/or haptic. Such notifications can be intrusive, especially when the user of the mobile computing device is in an environment where etiquette might dictate keeping such intrusions to a minimum.

The presently described subject matter provides a solution to the intrusive nature of mobile computing devices by determining an environment that the mobile computing device is in and changing the behavior of that mobile computing device accordingly. Changing the behavior of a mobile computing device may include muting alerts entirely when it is determined that the mobile computing device is in an environment where etiquette dictates that such intrusions are inappropriate. Changing the behavior of a mobile computing device may include muting audible alerts and increasing the intensity of the haptic feedback provided by the mobile computing device. The behavior of the mobile computing device can be modified in many ways, as described herein.

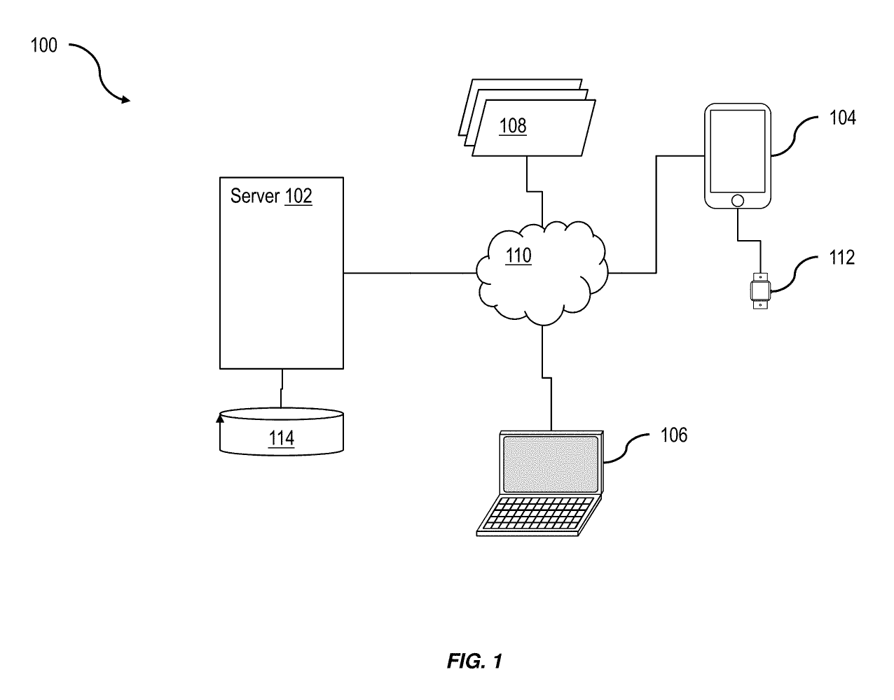

FIG. 1 is an illustration of a system 100 having one or more features consistent with the present description. The system 100 can include a server 102, a mobile computing device 104, a computing device 106, external resources 108, and one or more other elements. One or more of the elements, such as server 102, mobile computing device 104, computing device 106, external resources 108, or the like can be in electronic communication through a network 110. The network 110 can be, for example, the Internet. In some variations, a mobile computing device, such as a smartwatch 112 can be configured to connect to the mobile computing device 104. The smartwatch 112 can be configured to communicate with the mobile computing device 104, and one or more other elements of the system 100 through the connection of the mobile computing device 104 with the network 110.

FIG. 1 illustrates the mobile computing device 104 as a smartphone. This is for ease of illustration only and is not intended to be limiting. Similarly, other elements described in the figures are not meant to be limiting. A mobile computing device 104 can be a portable computing device, for example, a mobile computing device 104 can include one or more of a smartphone, smartwatch, fitness tracker, laptop, tablet, notebook, or the like.

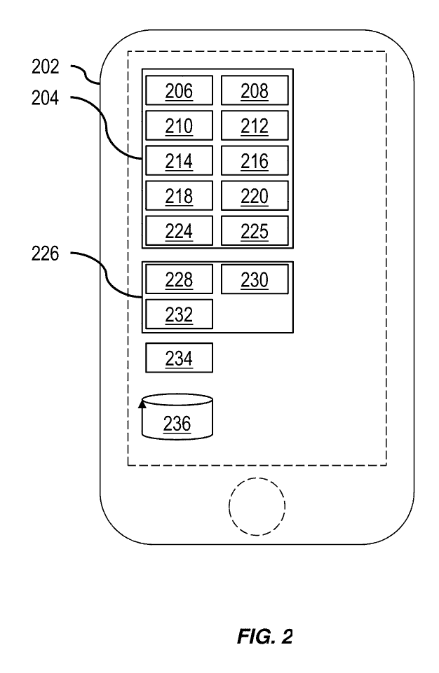

FIG. 2 is a schematic illustration of a mobile computing device 202 having one or more features consistent with the present description. The mobile computing device 202 can include one or more sensors 204. The one or more sensors 204 can be configured to monitor one or more contexts associated with an environment in which the mobile computing device 202 is in. The one or more sensors can include a microphone 206, a light sensor 208, a location sensor 210, a motion sensor 212, a pressure sensor 214, a proximity sensor 216, a temperature sensor 218, a pedometer 220, a heartrate monitor 222, a radiation sensor 224, cortisol and/or skin resistance sensor 225, or the like.

The mobile computing device 202 may include one or more transceivers 226. As used herein the term transceiver can refer to a single device that includes both a transmitter and a receiver, devices where the transmitter and receiver are separate, to a transmitter only or a receiver only. The one or more transceivers 226 can include a short-range communication protocol transceiver 228, a medium-range communication protocol transceiver 230, a long-range communication protocol transceiver 232, or the like. A short-range communication protocol transceiver 228 can be configured to transmit and/or receive communications in one or more of near-field-communication (NFC) protocols, Bluetooth® protocols, Bluetooth® 4.0 protocols, radio frequency identification (RFID) protocols, or the like. A medium-range communication protocol transceiver 230 can be configured to transmit and/or receive communications in one or more of Wi-Fi communication protocols, sub-gigahertz communication protocols, or the like. A long-range communication protocol transceiver 232 can be configured to transmit and/or receive communication in one or more of Code-Division Multiple Access (CDMA) communication protocols, General Packet Radio Service (GPRS) communication protocols, Long-Term Evolution (LTE) communication protocols, or the like.

The mobile computing device 202 can include an event logger 234. The event logger 234 can be configured to monitor and log events associated with the mobile computing device 202. For example, the event logger 234 can be configured to log when the user of the mobile computing device 202 interacts with the mobile computing device 202. The event logger 234 can be configured to log when a user of the mobile computing device 202 mutes the volume of notifications, turns off notifications, turns of the mobile computing device 202, turns on the mobile computing device 202, increases the volume of notifications, increases the brightness of a screen of a mobile computing device, or the like. The event logger 234 can be configured to monitor multiple aspects of a user's interaction with the mobile computing device 202.

The event logger 234 can be configured to log when the one or more transceivers 226 interact with an access node associated with the one or more transceivers 226. The event logger 234 can be configured to log an identity of the access node that the one or more transceivers 226 interact with. Interaction with an access node can include detecting the presence of an access node based on one or more broadcast messages from an access node, connecting to an access node, communicating with an access node, or the like.

The event logger 234 can be configured to log when one or more transceivers 226 interact with one or more peripheral devices to the mobile computing device 202 and/or log an identity of the one or more peripheral devices. The event logger 234 can be configured to log the types of interactions a user has with the one or more peripheral devices and/or the types of interactions the one or more peripheral devices has with the mobile computing device 202.

The event logger 234 can be configured to log information detected by the one or more sensors 204. The one or more sensors 204 can be configured to generate an output signal based on a sensing by the one or more sensors 204. For example, the microphone 206 can be configured to generate an output signal that includes an indication of the audible sounds detected by the microphone 206. The light sensor 208 can be configured to generate an output signal that includes an indication of the light levels detected by the light sensor 208. The location sensor 210 can be configured to generate an output signal that includes an indication of location information sensed by the location sensor 210. The motion sensor 212 can be configured to generate an output signal that includes an indication of motion detected by the motion sensor 212. The motion sensor 212 can include one or more sensors, for example, a gyroscope, an altimeter, a multi-axis sensor, or the like. The pressure sensor 214 can be configured to generate an output signal that includes an indication of a pressure detected by the pressure sensor 214. The proximity sensor 216 can be configured to generate an output signal that includes an indication of an objected detected proximate to the proximity sensor 216. In some variations, the proximity sensor 216 can be configured to generate an output signal that indicates how close the object got to the proximity sensor 216, how large the object was, the shape of the object, or the like. The temperature sensor 218 can be configured to generate an output signal indicative of a temperature detected by the temperature sensor 218. The pedometer 220 can be configured to generate an output signal indicative of a number of steps taken by a user of the mobile computing device 202, the number of flights of stairs climbed, or the like. The heartrate monitor 222 can be configured to generate an output signal indicative of a heartrate of a user of the mobile computing device 202. The radiation sensor 224 can be configured to generate an output signal indicative of an amount and/or type of radiation detected by the radiation sensor 224.

The event logger 234 can be configured to log information associated with the output signals received from the one or more sensors 204. The output signals from the one or more sensors 204 can include time information. The event logger 234 can be configured to add a timestamp to the logged output signal information.

The event logger 234 can be configured to log event information associated with data stored on the mobile computing device 202. For example, the event logger 234 can be configured to log an indication of when calendar information stored on the mobile computing device 202 indicates that a user of the mobile computing device 202 has a meeting. The event logger 234 can be configured to log a type of meeting, a date and time of the meeting, a location of the meeting, an indication of other participants in the meeting, or the like.

The mobile computing device 202 can include a memory 234. The memory can be configured to store an environment algorithm. The environment algorithm can be configured to receive information from one or more sources. For example, the environment algorithm can be configured to receive information from the event logger 234, the one or more sensors 204 and/or the one or more transceivers 226. The environment algorithm can be configured to facilitate determination of a context of an event associated with the mobile computing device 202. The environment algorithm can be configured to be self-learning. The environment algorithm can be configured to facilitate the storing of information to facilitate the environment algorithm to determine the context of the environment of the mobile computing device 202 at the time an event occurred.

In some variations, when detecting a new user interaction during a new event associated with the mobile computing device 202, a snapshot of all sensor information can be stored by the event logger 234. All information available from all sources can be stored by the event logger. In some examples, such as with complex smartphones or complex smartwatches, some sensor information may be unrelated with the user interaction. Some of the sensor information may be coincidental to the user interaction with the mobile computing device 102. Consequently, when a user of the mobile computing device 202, repeats the same user interaction, e.g., modifies the settings of the mobile computing device 202 in the same way, the context algorithm can be configured to create a another snapshot of all the sensor information. Subsequent snapshots of sensor information for a particular user interaction can be compared against existing snapshots for the same interaction. By looking at similarities between single sensors or groups of sensors in these snapshots, interaction related sensor information can be identified, and non-related sensor information can be discarded. A plurality of sensor information snapshotscan be analyzed to devise whether patterns exist in the information. Identified similarities in the sensor information can be used to improve existing patterns and increase the accuracy of the system over time.

In some variations, the context of an event associated with the mobile computing device 202 can be derived based on a context of an environment associated with the mobile computing device 202 at the time an event takes place, an indication of one or more other individuals involved with the event, an indication of words spoken during the event by the user and/or one or more other individuals involved with the event, a state of a user of the mobile computing device 202, or the like. A context of an environment associated with the mobile computing device 202 can include an amount of noise, a location, an amount of light in the environment, movement of the mobile computing device 202, the pressure of the environment, whether an object was close to the mobile computing device 202, a temperature of the environment, an amount of radiation in the environment, or the like. A state of the user of the mobile computing device 202 can be based on a heartrate of the user, a movement of the user, a location of the user, whether the user is proximate to the mobile computing device 202, or the like.

Examples of context determined based on information received can include a microphone 206 generating an output signal that includes an indication of a conversation being conducted by persons nearby. A determination can be made as to whether the user of the mobile computing device 202 is participating in the conversation. This can be determined by determining speech profiles of the participants in the conversation. When a speech profile of one of the participants matches the speech profile of a user of the mobile computing device 202, a determination can be made that the user of the mobile computing device 202 is participating in the conversation. The output signal from the microphone 206 can also include an indication of the level of volume of the conversation. The level of volume of the conversation can provide a context. A high-volume conversation may indicate that the participants are in a noisy environment or that the conversation is heated. A low level of volume may indicate that the conversation is occurring in a quiet environment or that the conversation is private.

As another example, a location sensor 210 may be configured to generate an output signal indicating a location of the mobile computing device 202. The output signal of the location sensor 202 may be monitored over time to determine a movement of the mobile computing device 202. For example, the output signal of the motion sensor 210, monitored over time, may indicate that the mobile computing device 202 is moving at highway speeds, is stationary, is at a particular location, for example, the user's workplace, the user's home, or the like.

Another example of context, determined by the information stored in the event logger 234, the one or more sensors 204, the one or more wireless transceivers 226, or the like, can include a state of the user. A state of the user can be determined based on information obtained from a heartrate monitor 222, cortisol and/or skin resistance sensor 225, or the like, to detect a stress level and/or physical activity level of the user of the mobile computing device 202.

As another example, a context can be determined based on information from the one or more transceivers 226 associated with the mobile computing device 202. The transceiver(s) 226 can be configured to detect the names of available networks, a signal strength of the available networks, current data throughput of the available networks, or the like.

As another example, a context can be determined based on information from a motion sensor 212 associated with the mobile computing device 202.

Whenever a user interaction is performed, the output signals generated by sensors of the mobile computing device 202 can reflects a current context of the user. In some variations, the event logger 234 can be configured to store a snapshot of all the sensor data obtained by sensor(s) of the mobile computing device 202. The snapshot of the sensor data can be stored in association with the user interaction.

The mobile computing device 202 can include memory 236. The memory 236 can be configured to store a context algorithm. The context algorithm can be configured to determine a context of an event associated with a mobile computing device 202. An event can include the mobile computing device 202 being used in a particular manner, the mobile computing device 202 being at a location, an calendar event associated with the user of the mobile computing device 202 occurring, a change in an environment associated with the mobile computing device 202, or the like.

The context algorithm can be self-learning. The context algorithm can be configured to use information stored in the event logger 234, information received from the one or more sensors 204 of the mobile computing device 202, information received from the one or more transceivers 226, or the like.

The self-learning context algorithm can be configured to monitor a change in one or more settings of the mobile computing device 202. The self-learning context algorithm can correlate the change in the one or more settings of the mobile computing device 202 with information stored in the event logger 234, information received from the one or more sensors 204, information received from the one or more transceivers 226, or the like. The self-learning context algorithm can analyze discrete items of information stored in the event logger 234, received from the one or more sensors 204, received from the one or more transceivers 226, or the like. The self-learning context algorithm can analyze the information stored in the event logger 234, received from the one or more sensors 204, received from the one or more transceivers 226, or the like, over time. Analyzing information over time can facilitate determination of patterns in the information. Patterns can be determined for the environment of the mobile computing device 202, a state of the users of the mobile computing device 202, calendar events associated with the user of the mobile computing device 202, or the like.

For example, the context algorithm can be configured to determine when a user of the mobile computing device 202 makes a specific user interaction with the mobile computing device 202, for example lowering a ringtone volume in response to the user entering a quiet room. The context algorithm can be configured to recognize a specific user interaction, for example, increasing the volume of the ringtone because the environment associated with the mobile computing device 202 increases.

In response to determining user interactions with the mobile computing device 202 that change one or more settings of the mobile computing device 202, the context algorithm can be configured to store a correlation between that user interaction with the mobile computing device 202 and the context of an event associated with the mobile computing device 202. In some variations, the context algorithm can store the correlation as a rule. Implementation of the rule, in response to detecting an event, having a particular context, associated with the mobile computing device, can cause the mobile computing device 202 to modify one or more of its settings.

The context algorithm can be configured to monitor the information stored in the event logger 234 to determine when an event having a particular context has occurred, is occurring, and/or will occur. The context algorithm can then automatically modify one or more settings of the mobile computing device 202 to put the mobile computing device in a state that correlates with the context of the event.

For example, if a user lowers the volume of the ringtone of the mobile computing device 202 in response to the user entering a quiet room, when the context algorithm detects that the mobile computing device 202 has entered a quiet room, the context algorithm can be configured to cause the mobile computing device 202 to lower the volume of the ringtone.

The event logger 234 can store information regarding received messages at the mobile computing device 202. In some variations, a user may receive many text messages from a particular contact. When the rate of receipt of messages from a particular contact increases beyond a certain amount, the context algorithm can be configured to cause the mobile computing device 202 to mute notifications of the messages from that user. In some variations, the rate of the notifications may be modified from the rate of receipt of messages. For example, notifications may be provided every five minutes, for example, instead of immediately when a message is received. Alternatively, notifications may be received every fifth message, for example, instead immediately for each message.

The context algorithm can be configured to modify notifications by type. For example, the context algorithm can be configured to determine that non-essential notifications are muted when a user is in the vicinity of another user. For example, notifications about sporting events may be muted when a mobile computing device 202 of a first user is in the vicinity of a mobile computing device 202 of a second user. Such notifications may be muted when the mobile computing devices 202 of the first user and the second user are co-located at a particular venue, for example, a restaurant, a bar, or the like.

When a mobile computing device 202 is in a mode where notifications are not presented to a user or have a reduced volume, the context algorithm can be configured to detect a subject of a message and determine whether to notify the user of the message despite the current settings of the mobile computing device 202. For example, the context algorithm can be configured determine, from a syntax of the message, whether the message is important. An important message may include a notification of a death in the family, an emergency at home, a work emergency, or the like. In some variations, the determination can be performed by the mobile computing device 202. In other variations, the determination can be performed by a server in electronic communication with the mobile computing device 202.

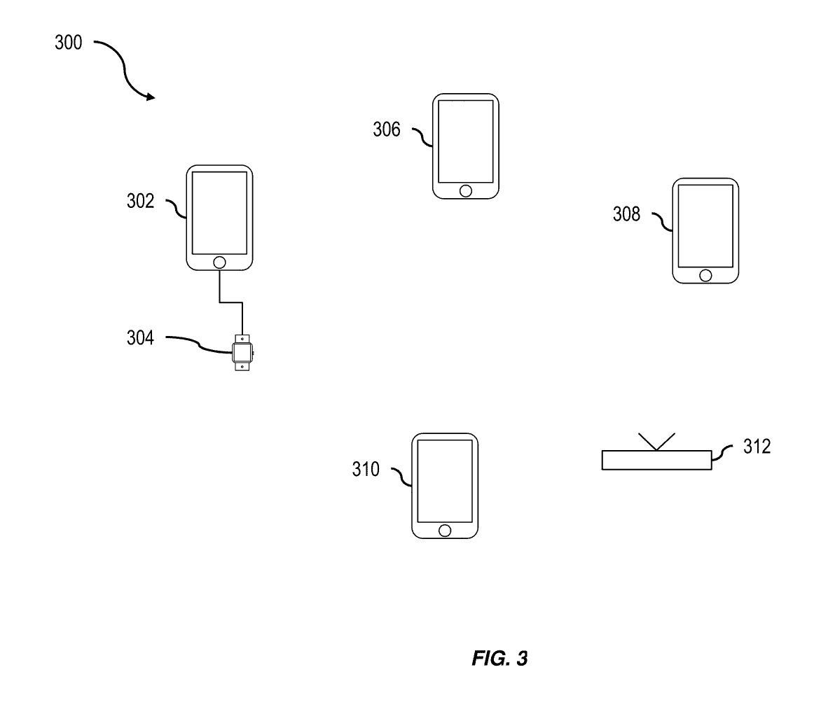

FIG. 3 is an illustration of a plurality of mobile computing devices having one or more features consistent with the present description. FIG. 3 illustrates an example of the present description where a plurality of mobile computing devices 302, 304, 306, 308, and 310 are in the vicinity of one another. A context of an event associated with a mobile computing device can be determined based on the proximity of the mobile computing device 302 with one or more other mobile computing devices 304, 306, 308, and 310.

The context algorithm can be configured to determine a context of an event associated with the mobile computing device 302, based on an identity of one or more other mobile computing devices 304, 306, 308 and/or 310. For example, the user of the mobile computing device 302 may belong to an organization, such as a company. The users of the other mobile computing devices 304, 306, 308 and/or 310 may also belong to the same organization. The mobile computing device 302, having one or more features consistent with the present description, can be configured to detect the identity of one or more mobile computing devices 304, 306, 308 and/or 310 within a particular distance of the mobile computing device 302.

Detection of whether the one or more mobile computing devices 304, 306, 308 and/or 310 are within a particular distance of mobile computing device 302 can be facilitated by a short-range communication protocol transceiver, for example, a short-range communication protocol transceiver 228. The mobile computing device 302 can be configured to detect the presence of the one or more mobile computing devices 304, 306, 308 and/or 310 through signals generated by the short-range communication protocol transceivers of the one or more mobile computing devices 302, 304, 306, 308 and/or 310.

Detection of whether the one or more mobile computing devices 304, 306, 308 and/or 310 are within a particular distance of mobile computing device 302 can be facilitated that through a wireless access node 312. A wireless access node 312 can, for example, be a Wi-Fi access node. The one or more mobile computing devices 302, 304, 306, 308 and/or 310 can be connected to the wireless access node 312. The mobile computing device 302 can be configured to query the wireless access node 312 to determine whether the one or more mobile computing devices 304, 306, 308 and/or 310 are connected to the wireless access node 312. In some variations, there may be multiple wireless access nodes. The mobile computing device 302 can be configured to determine a signal strength between the one or more mobile computing devices 304, 306, 308 and/or 310 and one or more of the wireless access nodes. A location of the one or more mobile computing devices 304, 306, 308 and/or 310 can be determined based on the signal strength between one or more of the wireless access points and the one or more mobile computing devices 304, 306, 308 and/or 310.

The user of the mobile computing device 302 may interact with the mobile computing device 302 to change one or more settings of the mobile computing device 302 when the mobile computing device 302 is within a particular distance from one or more of the other mobile computing devices 304, 306, 308 and/or 310. The context algorithm may be configured to store a correlation between the user changing the setting(s) of the mobile computing device 302 and the proximity of the mobile computing device 302 with the one or more other mobile computing devices 304, 306, 308 and/or 310. For example, the user may reduce or mute the volume of notifications from the mobile computing device 302 in response to being in a meeting with one or more users of the one or more other mobile computing devices 304, 306, 308 and/or 310.

A level of certainty that the user of the mobile computing device 302 is in a meeting with one or more of the users of the one or more other computing devices 304, 306, 308 and/or 310 can be enhanced through an electronic calendar of the user of the mobile computing device 302. The electronic calendar of the user of the mobile computing device 302 may include an entry for a meeting with one or more users of the one or more mobile computing devices 304, 306, 308 and/or 310. Based on the calendar entry indicating that a meeting is to take place at a certain time between known individuals, and an indication that mobile computing devices associated with those known individuals are all within a particular distance of one another, the context algorithm can deduce with greater certainty that a meeting is taking place. The context algorithm can cause one or more settings of the mobile computing device 302 to automatically change in response to a deduction that the user, of the mobile computing device 302, is in the meeting.

In some variations, users can be assigned to one or more user groups. For example, a user group can include a company user group, a family user groups, a friend user group, a location user group, or the like. In some variations, members of a company can be assigned to that company user group. The company user group can include one or more company sub-groups based on department, title, rank, role, or the like. Users belonging to the same user group may require their mobile computing devices to behave in a similar manner. For example, members belonging to a company user group may predominantly require their mobile computing devices to be quiet during meetings. A rule that requires the mobile computing device to mute notifications during meetings may be provided to all members of the company user group. Modifications made by users of the user group to such rules can be pushed to the other members of the group. The rules can be pushed to mobile computing devices of other users when a certain percentage of users of the user group adopt the modified rules.

In some variations, a user group may be associated with a group of users that require notifications to be increased when members of the user group are in the vicinity of each other. For example, a user group may be populated with emergency response personnel. When emergency response personnel are within the vicinity of each other, it can be an indication that they are working and require notifications to be readily apparent. A rule may exist for such a user group that increases the volume of the notifications when members of that user group are close together.

Referring to FIG. 1, a mobile computing device 104 can be connected to a server 102 through a network 110, for example, the Internet. In some variations, the processes described herein with respect to contextual analysis may be performed by the mobile computing device 104, the server 102, one or more third party resources 108, or the like. In some variations, some of the analysis may be performed by the mobile computing device 104 and some of the analysis may be performed by the server 102. Analysis requiring a relatively high level of processing and memory resources may be performed by the server 102 and/or third party resources 108. Analysis requiring a relatively low level of processing and memory resources may be performed by the mobile computing device 104.

For example, the mobile computing device 104 can be configured to transmit sound information to the server 102 through a network 108, such as the Internet. The server 102 can be configured to analyze the sound files to determine, for example, whether the sound profile of the user of the mobile computing device 104 can be detected in the sound file. The mobile computing device 104, for example, can be configured to analyze an ambient noise level of the sound in the sound file.

The mobile computing device 104 can be configured to receive additional information from the server 102, third-party resources 108, one or more other computer devices 106, or the like, to facilitate determination of a context of an event associated with the mobile computing device 102.

Information obtained by the mobile computing device 102, for example, information obtained by the one or more sensors 204, the one or more wireless transceivers 226, or the like, can be stored in a cloud computing system. The cloud computing system can include one or more servers 102. The one or more servers 102 can include one or more memories 114. Information obtained by the mobile computing device 102, for example, information obtained by the one or more sensors 204, the one or more wireless transceivers 226, or the like, can be stored in memory 114. Contextual information determined by a context algorithm of a mobile computing device 102 can be uploaded to a cloud computing system and stored in memory 114.

Information from a plurality of mobile computing devices can be uploaded to a cloud computing system and stored in memory of a cloud computing system. The cloud computing system can be configured to perform analysis on the uploaded information. The cloud computing system can have greater processing and memory capabilities compared to mobile computing devices. The cloud computing system can be configured to analyze the information to refine rules associated with modifying one or more settings of a mobile computing device in response to determining a context of an event associated with the mobile computing device.

For example, it can be determined that a majority of users of mobile computing devices modify the settings of their mobile computing devices in a similar manner for similar events. For example, it may be determined that a majority of users of mobile computing devices reduce or mute the volume of notifications when in a movie theatre. A mobile computing device, such as mobile computing device 104, can be configured to receive a rule from the cloud computing system, to reduce the volume and/or mute notifications when a location sensor, such as location sensor 210, generates an output signal indicating a location associated with a movie theatre.

The mobile computing device 104 can be configured to present a recommendation for a behavior to the user of the mobile computing device 104. The recommendation can appear on a display of the mobile computing device. For example, after receiving a rule, from, for example, a cloud computing system, that would cause notifications to be muted when the mobile computing device 104 is in a movie theatre, the user can be presented with that rule on a display of the mobile computing device 104. The user can interact with the recommendation on the display to activate the rule, modify the rule, or disregard the rule.

In this manner, the mobile computing device 104 can be configured to refine its automated responses to events without the user of the mobile computing device 104 having to intervene.

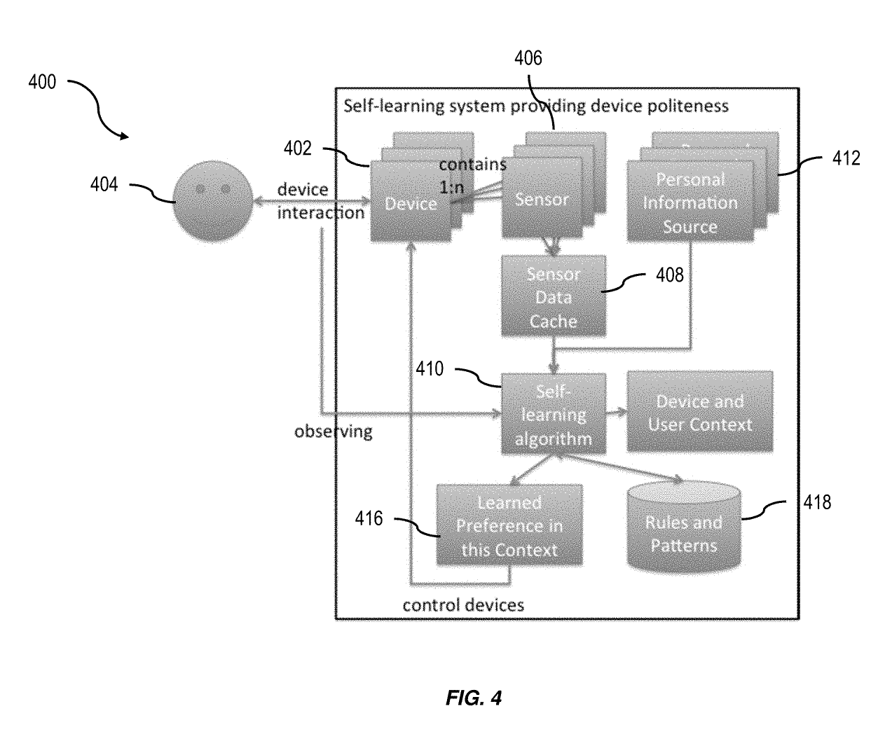

FIG. 4 is an illustration of a system architecture 400 having one or more features consistent with the present description. The system architecture 400 can include a mobile computing device 402. A user 404 can interact with the mobile computing device 402. The user 404 can interact with the mobile computing device 402 in response to a context of an environment of the mobile computing device 402.

The mobile computing device 402 can include one or more sensors 406. The one or more sensors 406 can be configured to obtain information associated with an environment of the mobile computing device 402. Sensor information obtained by the sensor(s) 406 can be stored in a sensor cache 408. The sensor data cache 408 can keep a historical record of the sensor information obtained by the sensor(s) 406.

The mobile computing device 402, and/or a server in electronic communication with the mobile computing device 402, can include a self-learning algorithm 410. The self-learning algorithm 410 can be configured to receive information from the sensor data cache 408. The self-learning algorithm 410 can be configured to receive information from a personal information source 412. The personal information source 412 can include calendar information, contact information, message information, or the like. The self-learning algorithm 410 can be configured to receive user interaction information. The user interaction information can include lowering a volume of notifications, rising a volume of notifications, or the like.

The self-learning algorithm 410 can be configured to determine the user interactions from a user 404 in the context of server information obtained from the sensors 406. The self-learning algorithm can be configured to generate one or more rules and detect patterns representative of re-occurring behavior of given situations as observed by the user interactions with the mobile computing device 402, the sensors 406, or the like. The rules and patterns can be stored in memory 418.

The self-learning algorithm 410 can be configured to store a learned preference in particular contexts in a memory 416. The stored learned preference can be configured to control the functionality of the mobile computing device 402. When the sensors 406 and or personal information 412 detect a particular context associated with the mobile computing device 402, the mobile computing device 402 can be configured control the one or more functions of the mobile computing device 402.

One or more features described herein can be performed using one or more processors. The one or more processors that perform the one or more features may be part of a mobile computing device 104, a server 102, a third party resource 108, one or more other computing device 106, or the like. The processor(s) is configured to provide information processing capabilities to a computing device having one or more features consistent with the current subject matter. The processor(s) may include one or more of a digital processor, an analog processor, a digital circuit designed to process information, an analog circuit designed to process information, a state machine, and/or other mechanisms for electronically processing information. The processors can be a single entity, a plurality of processing units, or the like. These processing units may be physically located within the same device, or may be located in a plurality of devices operating in coordination. The processor(s) may be configured to execute machine-readable instructions, which, when executed by the processor(s) may cause the processor(s) to perform one or more of the functions described in the present description. The functions described herein may be executed by software; hardware; firmware; some combination of software, hardware, and/or firmware; and/or other mechanisms for configuring processing capabilities on the processor(s).

Memory 114 may comprise electronic storage media that electronically stores information. The electronic storage media of memory 114 may include one or both of system storage that is provided integrally (i.e., substantially non-removable) with a computing device, such as server 102, mobile computing device 104, one or more other computing devices 106, third party resources 108, or the like, and/or removable storage that is removably connectable to server 102 via, for example, a port (e.g., a USB port, a firewire port, etc.) or a drive (e.g., a disk drive, etc.). Memory 114 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The memory 114 may include one or more virtual storage resources (e.g., cloud storage, a virtual private network, and/or other virtual storage resources). Memory 114 may store software algorithms, information determined by the processor, information received from one or more computing devices, such as server 102, client computing devices 104, or the like, information that enables the one or more computing device to function, or the like.

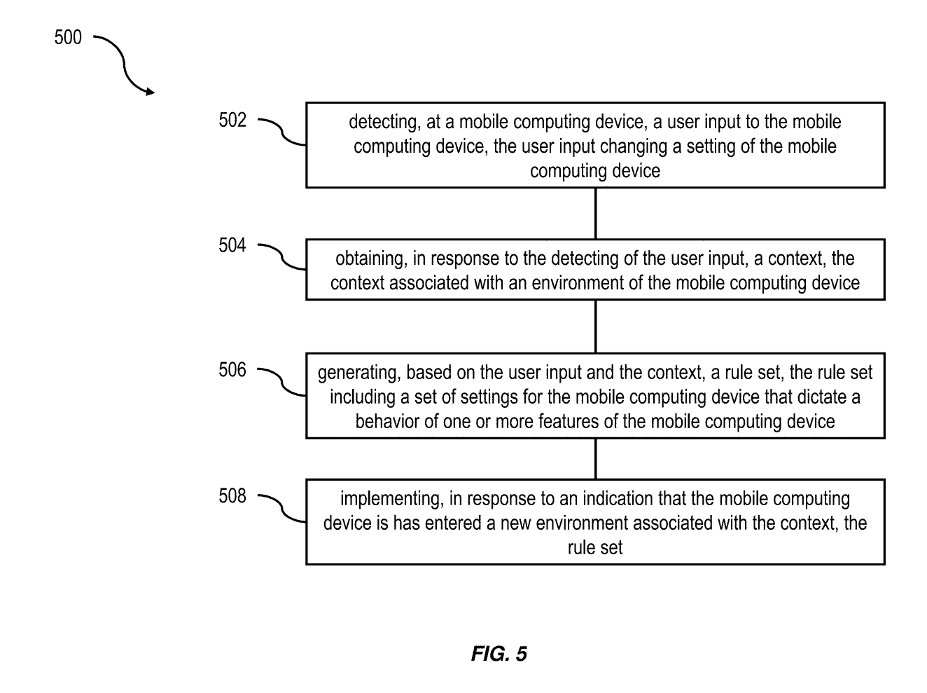

FIG. 5 illustrates a method 500 having one or more features consistent with then current subject matter. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At 502, a user input to the mobile computing device can be detected. The user input can be detected by the mobile computing device. The user input can change a setting of the mobile computing device.

At 504, context information associated with the user input can be obtained. The obtaining of the context information associated with the user input can comprise determining a context of an environment in which the mobile computing device is located. The context can be determined based on the output signal from one or more sensors of the mobile computing device. In some variations, the sensor(s) can be a microphone and the context of the environment can include a noise level of the environment. The sensor(s) can be a transceiver and the context of the environment can include a plurality of other mobile computing devices within a predefined distance of the mobile computing device.

At 506, a rule set can be generated. The rule set can be generated based on the user input and the context. The rule set can include a set of settings for the mobile computing device that dictate a behavior of one or more features of the mobile computing device. The set of settings can cause the mobile computing device to have a behavior consistent with the set of settings. The set of settings can include a volume of a notification sound of the mobile computing device.

In some variations, generating a rule set can be include determining a pattern. The pattern can be between a plurality of user inputs to the mobile computing device and a plurality of contexts associated with an environment of the mobile computing device.

At 508, the rule set can be implemented. The rule set can be implemented in response to an indication that the mobile computing device has entered a new environment associated with the context.

In some variations, where the mobile computing device is associated with a user belonging to a user group, the method may further include receiving, from a server at the mobile computing device, a user group set of settings, the user group set of settings associated with the user group. The user group set of settings can be implemented by the mobile computing device.

Without in any way limiting the scope, interpretation, or application of the claims appearing herein, a technical effect of one or more of the example embodiments disclosed herein may include mobile computing devices automatically sensing context information associated with an environment of the mobile computing device and reacting accordingly based on machine-learning algorithms.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method to be performed by at least one computer processor forming at least a part of a computing system, the method comprising:
detecting, at a mobile computing device, a user input to the mobile computing device, the user input changing a setting of the mobile computing device in response to an event;
obtaining, in response to the detecting of the user input, a context, the context associated with an environment of the mobile computing device and the event, wherein obtaining the context is based on an output signal generated by a sensor of the mobile computing device;
generating, based on the user input and the context, a rule set, the rule set including a set of settings for the mobile computing device that dictate a behavior of one or more features of the mobile computing device; and
implementing, in response to an indication that the mobile computing device has entered a new environment associated with the context, the rule set, wherein implementing the rule set comprises modifying a notification to a user of the mobile computing device based on a type of notification.

2. The method of claim 1, wherein the obtaining of the context is based on a stress level and/or physical activity level of the user.

3. The method of claim 1, wherein the output signal includes an indication of an environmental factor of the environment of the mobile computing device.

4. The method of claim 1, wherein the sensor is a microphone and the context of the environment includes a a speech profile of a participant in a conversation.

5. The method of claim 1, wherein the sensor comprises a transceiver and the context of the environment includes a plurality of other mobile computing devices within a predefined distance of the mobile computing device.

6. The method of claim 1, wherein the obtaining of the context is based on personal information associated with a user of the mobile computing device.

7. The method of claim 1, wherein the obtaining of the context further comprises:
receiving, at the mobile computing device, a message; and
determining, in response to receiving the message, a subject matter of the message, wherein implementing the rule set further comprises notifying the user based on the subject matter of the message.

8. The method of claim 1, wherein the set of settings includes a volume of a notification sound of the mobile computing device.

9. The method of claim 1, wherein the mobile computing device is associated with a user belonging to a user group and the method further comprises:
receiving, from a server at the mobile computing device, a rule set associated with the user group; and
implementing, by the mobile computing device, the rule set associated with the user group.

10. The method of claim 1, wherein the generating of the rule set includes:
determining a pattern between a plurality of user inputs to the mobile computing device and a plurality of contexts associated with an environment of the mobile computing device;
generating, based on the determined pattern, the rule set.

11. A mobile computing device comprising:
a sensor configured to generate an output signal;
at least one processor; and
at least one memory including program code which when executed by the at least one processor causes operations comprising:
detecting, at the mobile computing device, a user input to the mobile computing device, the user input changing a setting of the mobile computing device in response to an event;
obtaining, in response to the detecting of the user input, a context, the context associated with an environment of the mobile computing device and the event, wherein obtaining the context is based on the output signal generated by the sensor;
generating, based on the user input and the context, a rule set, the rule set including a set of settings for the mobile computing device that dictate a behavior of one or more features of the mobile computing device; and
implementing, in response to an indication that the mobile computing device has entered a new environment associated with the context, the rule set, wherein implementing the rule set comprises modifying a notification to a user of the mobile computing device based on a type of the notification.

12. The mobile computing system of claim 11, wherein the obtaining of the context is based a stress level and/or physical activity level of the user.

13. The mobile computing device of claim 11, wherein the output signal includes an indication of an environmental factor of the environment of the mobile computing device.

14. The mobile computing device of claim 11, wherein the sensor is a microphone and the context of the environment includes a a speech profile of a participant in a conversation.

15. The mobile computing device of claim 11, wherein modifying the notification comprises muting non-essential notifications.

16. The mobile computing device of claim 11, wherein the obtaining of the context is based on personal information associated with a user of the mobile computing device.

17. The mobile computing device of claim 11, wherein the obtaining of the context further comprises:
receiving, at the mobile computing device, a message; and
determining, in response to receiving the message, a subject matter of the message, wherein implementing the rule set further comprises notifying the user based on the subject matter of the message.

18. The mobile computing device of claim 11, wherein the set of settings includes a rate of notifications to the user of the mobile computing device.

19. The mobile computing device of claim 11, wherein the mobile computing device is associated with a user belonging to a user group and the operations further comprise:
receiving, from a server at the mobile computing device, a rule set associated with the user group;
implementing, by the mobile computing device, the rule set associated with the user group.

20. The mobile computing device of claim 11, wherein the generating of the rule set includes:
determining a pattern between a plurality of user inputs to the mobile computing device and a plurality of contexts associated with an environment of the mobile computing device; and
generating, based on the determined pattern, the rule set.
